(19) United States
(12) Patent Application Publication
(10) Pub. No.: US 2002/0133688 A1
(43) Pub. Date: Sep. 19, 2002

(54) SIMD/MIMD processing on a reconfigurable array

(76) Inventors: Ming-Hau Lee, Irvine, CA (US); Fadi Kurdahi, Irvine, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/772,591

(22) Filed: Jan. 29, 2001

(51) Int. Cl. G06F 15/00

(52) U.S. Cl. 712/22

(57) ABSTRACT

A system and method for programming an M×N array of cells. Each cell is reconfigurable to execute a function according to a context instruction. The context instruction defines an operation of the array. An enable register includes a row enable register and a column enable register, corresponding to the M rows and N columns. Each cell is individually and independently enabled for receiving a next context instruction, according to an enable signal provided by the enable register. Non-enabled cells execute a present context. Enabled cells receive and execute an updated context. In this way, the array of cells can be configured to execute any number of independent functions for the operation.

### BACKGROUND OF THE INVENTION

The present invention relates generally to computer processors. More specifically, the present invention relates to a reconfigurable processor architecture for SIMD/MIMD processing.

Single instruction, multiple data (SIMD) processors are a type of processor that executes one instruction on different data items. In an array of processor cells, each cell is configured to execute the same instruction. Data on which the same instruction is executed by multiple cells is known as block data. SIMD processors have relatively simple architectures, and are sufficiently powerful for applications that process block data.

However, SIMD processors are inefficient for applications that require adaptive processing of heterogeneous data. The term heterogeneous data relates to data being processed by multiple processing cells, at least a portion of which execute different instructions. Multiple instruction, multiple data (MIMD) are a type of processor in which several different instructions are executed, for processing different data items. MIMD processors can support heterogeneous applications, but are much more costly and complex to program. Further MIMD processors are more difficult to interface to other MIMD processors for scalability.

What is needed is a processor having the simplicity and efficiency of a SIMD, yet the adaptability and scalability of a MIMD.

### SUMMARY OF THE INVENTION

This invention relates to processing architectures and methods of processing data. In an embodiment of the invention, an array of SIMD) processor cells includes control and logic circuitry for dynamic reconfiguration of individual cells for MIMD-type functionality.

In one embodiment, an apparatus for programming an M×N array of reconfigurable processor cells, where each cell being operative according to a context instruction, includes an enable register, and an execution mode generator. The enable register is connected to the array and having an enable signal for controlling an active state of selected cells in the array. The execution mode generator is connected to each cell in the array and provides an execution mode signal for controlling delivery of a next context instruction to each active cell in the array based on the enable signal.

In another embodiment of the invention, a SIMD/MIMD processing system includes a plurality of reconfigurable processing cells, wherein a junction of each cell is operative according to a context, a controller for controlling an execution mode of the array, wherein each cell of the array executes either a present or an updated context during each clock cycle, and an enable register for selectively enabling a subset of cells in the array for receiving the updated context instruction while all non-enabled cells maintain the present context. In accordance with the embodiment, the internal states of each cell are updated by the context register only when the cell is in an active state, wherein the active state is based on the execution mode.

In yet another embodiment of the invention, a method of programming an M×N array of cells includes enabling a sub-unit of cells for a new context instruction, wherein each non-enabled cell maintains its present context instruction, and providing the new context instruction to each cell in the sub-unit. Alternatively, a method of programming an M×N array of cells includes selecting an execution mode for each cell in the array, executing a present context by each cell having an asserted execution mode bit, and executing an updated context by each cell having an unasserted execution mode bit.

### BRIEF DESCRIPTION OF THE DRAWING

FIG. 1 shows a dynamically reconfigurable processing architecture including an M×N array of reconfigurable cells.

FIG. 2 illustrates an internal structure of one reconfigurable cell according to an embodiment of the invention.

FIG. 3 depicts an M×N array of reconfigurable cells with enable registers.

FIG. 4 depicts a control signal source according to one embodiment of the invention.

### DETAILED DESCRIPTION OF THE PREFERRED EMBODIMENTS

As described above, processor architectures for (MIMD) processing are normally complex and difficult to interface together. The present invention overcomes the aforementioned limitations of conventional SIMD or MIMD processors by providing an architecture and control structure for performing SIMD/MIMD processing with a reconfigurable array of processing cells.

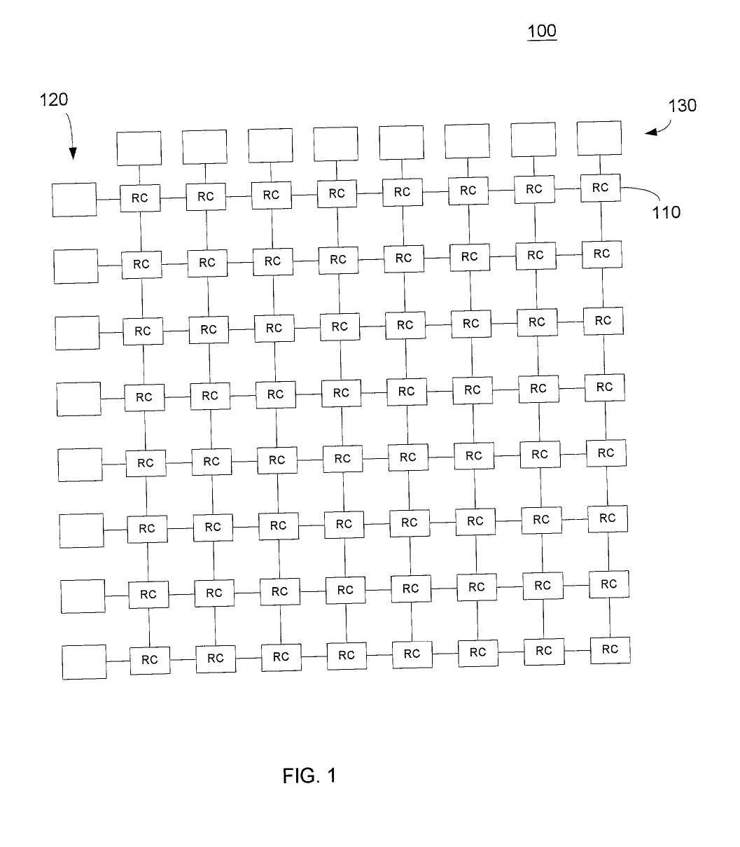

FIG. 1 shows a dynamically reconfigurable processing structure 100 in accordance with an exemplary embodiment of the invention. The processing structure 100 includes an M row× N column array of reconfigurable cells 110. In the exemplary embodiment, the M×N array is an 8×8 array of cells 110. Each cell 110 is a processor that is configured, and reconfigurable, for performing one or more logic function. Each row M is controlled by a row decoder 120, which is configured to address and instruct all cells in the entire row. Each column N is controlled by a column decoder 130 configured to address and provide instructions to all cells in the entire column.

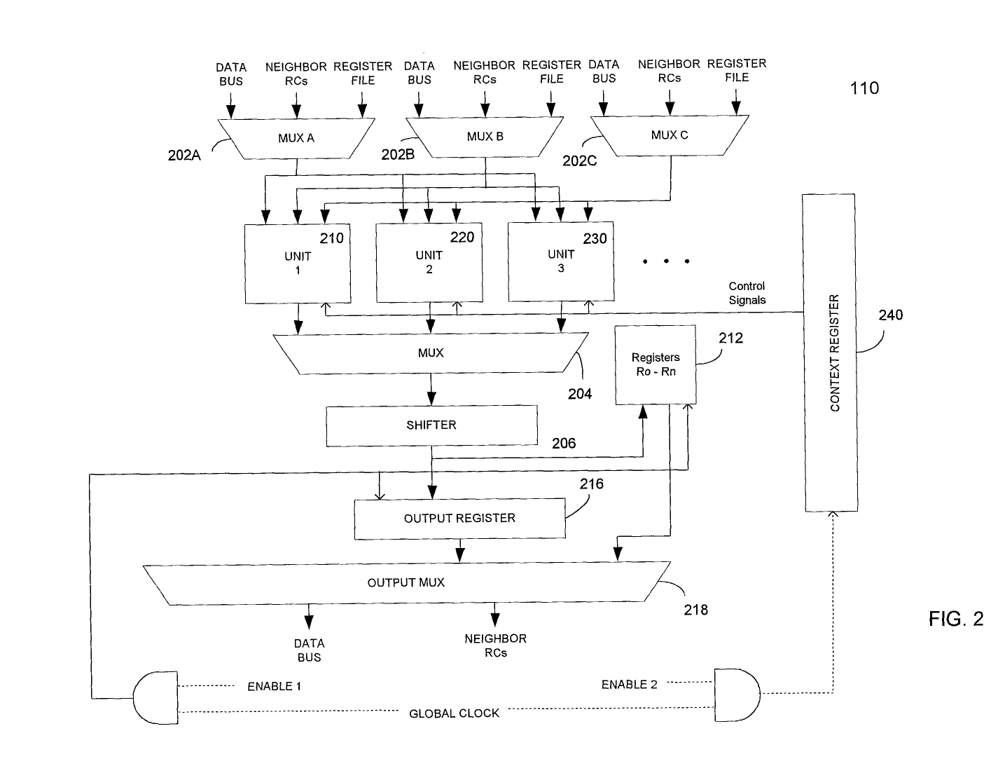

FIG. 2 illustrates the internal structure of one cell 110 according to the exemplary embodiment of the invention. In the exemplary embodiment, the cell 100 includes one or more functional units 210, 220 and 230. The combination of functional units 210, 220 and 230 defines an operation unit of the cell, and represents a logical function executed by the cell 110. Suitable functional units include, but are not limited to, a Multiply-and-Accumulate (MAC) functional unit, an arithmetic unit, and a logic unit. Other types of functional units for performing functions are possible. The functional units 210, 220 and 230 are configured in the cell 110 in a modular fashion, in which other functional units can be added, or present functional units can be removed. In particular, by adding functional units, the range of functions of the cell 110 is expandable and scalable. The modular design of the exemplary embodiment also makes decoding of the function easier.

In one embodiment of the invention, only one of the functional units 210, 220 or 230 is active at a time during one clock cycle. The functional units are controlled and activated by a context register 240. The context register 240 latches a context instruction upon each processing cycle, and provides the context instruction to the appropriate functional unit(s). In other embodiments, depending upon the structure and logic of the group of functional units, and based on the context of the cell, more than one functional unit can be activated at a time.

Each cell 110 contains a register file 212 for storing temporary data, such as a result of logical computations by the functional units 210, 220 and 230, for example. In the example, the result of each functional unit is combined together by multiplexer 204, output to a shifter 206, and provided to an output register 216. The data output of the shifter 206 is also provided to the register file 212, where it is temporarily stored until replaced by a new set of output data from the combination of functional units 210,220 and 230. The output register 216 sends the output data to an output multiplexer 218, from which the output data, representing a processing result of the reconfigurable cell, is sent to either the data bus, to a neighboring cell, or both.

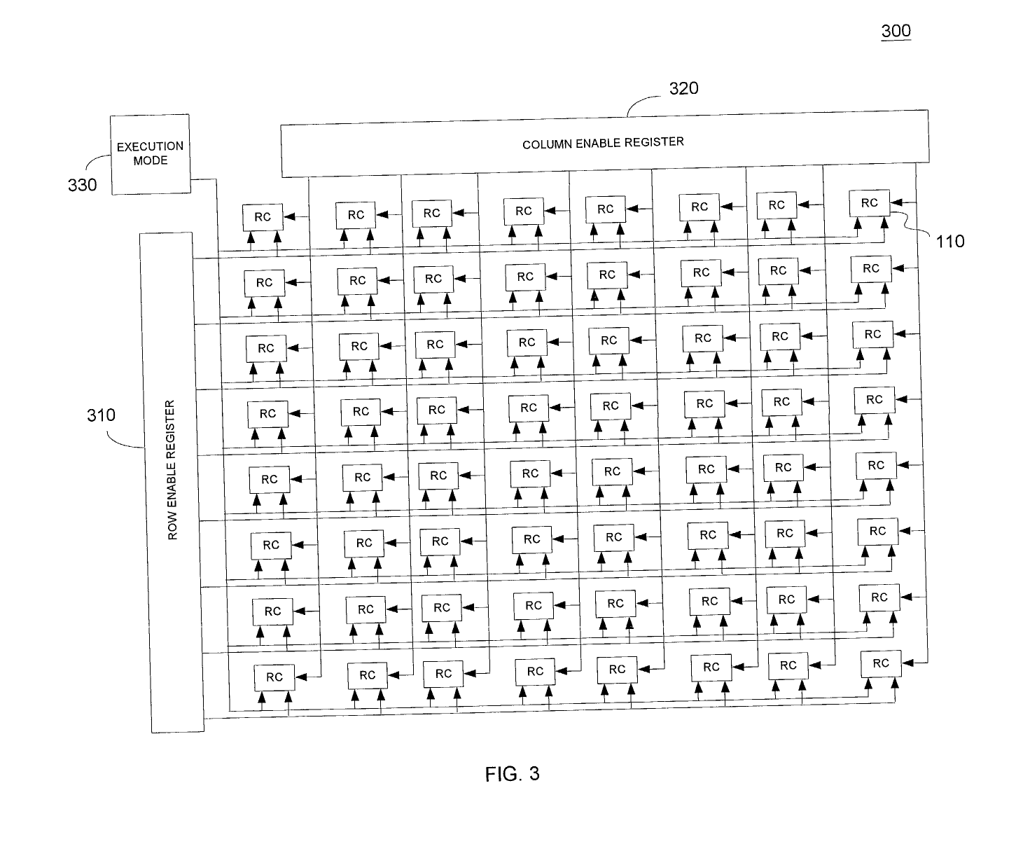

An CONTROL1 signal is gated with a clock signal for controlling most or all of the sequential logic elements within the cell 110. The CONTROL1 signal controls the flow of data to be operated upon by the cell 110. An CONTROL2 signal is gated with the clock signal for controlling the context register 240. The CONTROL2 signal controls the flow of a the context instruction to the cell 110 for controlling the operation of the cell 110. The context register 240 stores a next context instruction upon each clock cycle, and provides the next context instruction to the functional units 210, 220 and 230. The CONTROL1 and CONTROL2 signals are based on the enable signals provided by row and column enable registers 310 and 320, respectively, and an execution mode generator 330, described with reference to FIG. 3.

As stated above, a present function of the cell 110 is controlled by a context. The context defines logic and data to be executed by the functional units 210, 220 and 230. The context is broadcast to cells 110 in a row M or column N in the M×N array from a context memory connected to a context register 240. The context memory is placed at the periphery of the array 100. Thus, the processor structure using the array of cells can operate in SIDM mode, i.e. executing the same instruction on different data items. Instructions suitable for SIMD mode include, but are not limited to, matrix and vector operations.

FIG. 3 shows a processor array 300 with configuration control for implementing MIMD functions in a SIMD array, in accordance with an embodiment of the invention. In the embodiment, an execution mode signal generator 330 is gated to all cells in the array to decide the execution mode of the array 300. An M-bit row enable register 310 is connected to each row of the M×N array. An N-bit column enable register 320 is connected to each column of the M×N array. The clock signal of the context register for each cell in the array is gated with the enable signal from each of the row and column enable registers 310, 320 and the execution mode signal for the execution mode generator 330. Depending upon the values in each enable register 310, 320, the context registers 240 of a subset of the cells 110 in the M×N array 300 can receive updated contexts at any given time, thereby forming a “mask” over the array 300. This mask can be updated at each cycle, if needed. For a particular cell to be active, both corresponding bit lines from the row and column enable registers 310 and 320 must carry a logically active signal, such as a logical “1” for example, depending on a desired convention.

When the array 300 is in SIMD execution mode, represented by a “00” state of the execution mode generator 330, each enabled cell 110 receives a new context instruction. The context instruction is loaded into the cell 110 for each subsequent clock cycle so long as the execution mode signal to the cell 110 remains unchanged. Although the context instruction can be dynamically updated every cycle, the cells 110 in each row/column preferably execute the same context instruction. When the array 300 is in MIMD execution mode (state ‘10’), the current context instruction for each enabled cell 110 is maintained. When the context instruction is maintained, the cell 110 is effectively “frozen” to repeatedly execute that context instruction, until a new context instruction is designated for the cell 110. When the array 300 is Programming mode (state “01”), the internal states of each cell 110 are not updated by their associated context registers 240, and an updated context can be broadcast to each cell 110 enabled by the enable registers 310, 320. Table 1 summarizes the various execution modes of the array 300.

TABLE 1

| STATE | EXECUTION MODE |
|---|---|
| 00 | Default. Array is in SIMD execution mode. The enable registers |
| | are also in the default state, which is 0. Each cell receives new |
| | context, and executes on it every clock cycle. |
| 01 | Context distribution mode (i.e. “programming mode”). Array is |
| | being programmed into an MIMD machine. The enable registers |
| | are set to a certain value, and the contexts are broadcast to the |
| | selectively enabled cells. In this mode, the internal state of each |
| | cell will not be changed. |
| 10 | MIMD execution mode. After the array is programmed as a |
| | MIMD machine, the enable registers are released and reset, and |
| | the execution mode generator is set to “10.” The array stops |
| | receiving new contexts, and executes on the present contexts. |
| 11 | “don't care” |

By selectively enabling the context registers of a subset of cells 110 in the array, it is possible to broadcast context instructions to each active-masked or enabled cell. Accordingly, by enabling subunits representing one or more cells 110 within the array 300, different portions of the array 300 can be configured to execute different operations. Further, different operations are the result of different functional units being activated by the context instruction, which can occur even within the same row and/or column. It is therefore possible to separately program each individual cell to perform a different function, yielding M×N different operations. Thus, a reconfigurable cell array 300 according to the invention can be configured as a one-dimensional vector processor, or as a two-dimensional array processor.

The reconfigurable cells in an array are interconnected according to one or more hierarchical schemes. In one exemplary embodiment, for an 8×8 array for example, cells within a quadrant, i.e. each group of 4×4 cells, are fully connected in a row or column. Further, cells in adjacent quadrants are connected via specially-configured fast lanes that enable a cell in one quadrant to broadcast function results to all cells in an adjacent quadrant.

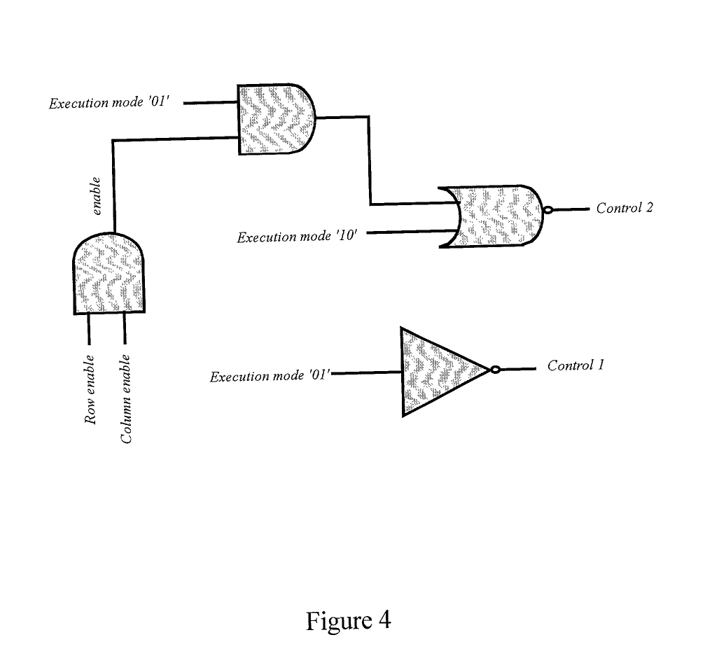

FIG. 4 depicts a configuration for generating the CONTROL1 and CONTROL2 signals using the enable signals and the execution mode signal. The execution mode ‘01’signal is inverted to produce the CONTROL1 signal. A row enable signal is provided from the row enable register, and combined with a column enable signal provided from the column enable register. The combined enable signal is provided to a AND gate with the execution mode ‘01’signal, and the output of the AND gate is connected to a NOR gate with the execution mode ‘10’signal to produce the CONTROL2 signal. Other configurations and methods for producing the CONTROL1 and CONTROL2 signals will be readily apparent to a person of ordinary skill in the art.

Other embodiments, combinations and modifications of this invention will occur readily to those of ordinary skill in the art in view of these teachings. Therefore, this invention is to be limited only be the following claims, which include all such embodiments and modifications when viewed in conjunction with the above specification and accompanying drawings.

What is claimed is:

1. An apparatus for programming an M×N array of reconfigurable processor cells, each cell being operative according to a context instruction, comprising:
an execution mode signal generator, connected to each cell in the array and having an execution mode signal for controlling an execution mode of each cell; and
an enable register connected to the array and providing an enable signal to each cell in the array for controlling delivery of a next context instruction to each enabled cell based on the execution mode.

2. The apparatus of claim 1, wherein the enable register further comprises:
a row enable register connected to each row of the array and having an M-bit row enable signal for controlling an active state of each cell in a row; and
a column enable register connected to each column of the array and having an N-bit column enable signal for controlling an active state of each cell in a column.

3. The apparatus of claim 1, further comprising a context memory, responsive to the enable signal and the execution mode signal for delivering the next context instruction to each active cell in the array.

4. The apparatus of claim 1, wherein a default state of each cell in the array is an enabled state.

5. The apparatus of claim 1, further comprising an enable signal loader connected to the enable register and responsive to an address signal for selecting a subset of cells in the array for enabling.

6. The apparatus of claim 3, wherein the context memory includes a context register connected to each cell in the array, wherein the context register is connected to the enable signal.

7. A SIMD/MIMD system for processing data, comprising:
an M row × N column array of independently enabled processing cells, wherein each cell includes a context register for storing a context instruction which controls an operation unit of the cell;
an enable register having a row enable register for providing a row enable signal to each row in the array, and a column enable register for providing a column enable signal to each column in the array;
an execution mode generator for generating an execution mode signal for controlling an execution mode of the array; and
a control circuit connected to each processing cell, each control circuit having inputs for receiving the row enable signal, the column enable signal, and the execution mode signal, and including logic that outputs a first control signal for controlling input of the data to the operation unit of the cell, and a second control signal for controlling input of the context instruction to the context register of the cell.

8. The system of claim 7, wherein the execution mode of the array includes:
a SIMD mode in which each enabled cell repeatedly executes on an updated context instruction;
a programming mode in which an plurality of updated contexts are broadcast to the enabled cells, and the function of each cell is not updated; and
a MIMD mode in which the context registers are frozen and each cell executes on its present context; and

9. A method, comprising:
enabling a sub-unit of cells for a new context instruction in an M×N array of cells, wherein each non-enabled cell maintains its present context, instruction; and
providing the new context instruction to each cell in the sub-unit.

10. The method of claim 9, wherein each masked cell keeps its internal states and the present context.

11. A method of programming a operations context for a M×N array of cells, comprising:
selecting an execution mode for each cell in the array, wherein the execution mode includes a MIMD execution mode and a SIMD execution mode;
executing, by each cell having the MIMD execution mode, a present context; and
executing, by each cell having the SIMD execution mode, an updated context.

12. A dynamically reconfigurable processing cell for an M×N array of cells, comprising:
a clock signal input for receiving a global clock signal;
at least one functional unit configured to execute an operation;
a context register, connected to each functional unit, configured to output a context instruction that controls each functional unit;
a register file for storing a result from said at least one functional unit;
a first control input connected to the register file for receiving a first enable signal that controls latching of the result from said at least one functional unit by the register file; and
a second control input connected to the context register for receiving a second enable signal that controls latching of a next context instruction by the context register.

13. The cell according to claim 12, wherein the first enable signal is configured to activate the plurality of sequential processing elements.

14. The cell according to claim 12, wherein the second enable signal is configured to activate the context register, wherein the context register is adapted to receive a new context instruction only in the active state.

15. The cell according to claim 12, wherein the first and second inputs are responsive to an enable signal provided by an external enable register.
